(19) United States
(12) Patent Application Publication
(10) Pub. No.: US 2008/0120612 A1
(43) Pub. Date: May 22, 2008

(54) Limited installation medium

(75) Inventor: Patrick Larroche, New York, NY (US)

Correspondence Address: Henry Blanco White, Esq.;Drinker Biddle & Reath LLP, One Logan Square, 18th and Cherry Street, Philadelphia, PA, 19103-6996, US

(73) Assignee: FDD Technologies sa/ag/ltd, Zug (CH)

(21) Appl. No.: 11/985,197

(22) Filed: Nov. 13, 2007

Related U.S. Application Data
(60) Provisional application No. 60/860,615, filed on Nov. 22, 2006.

(51) Int. Cl. G06F 9/445

(52) U.S. Cl. 717/174

(57) ABSTRACT

A storage medium contains information including a setup program comprising instructions for causing a computing device to install other parts of the information on the computing device. In normal use, reading the storage medium causes at least a selected part of the information on the storage medium to become unreadable within a predetermined time. The computing device reads the selected part of the information both before and after the predetermined time. The setup program installs the other parts of the information only if the selected part of the information is both readable before the predetermined time and unreadable after the predetermined time.

### CROSS-REFERENCE TO RELATED APPLICATIONS

This application claims the benefit of my U.S. Provisional Patent Application No. 60/860,615, titled Limited Installation Medium, filed Nov. 22, 2006, which is incorporated herein by reference in its entirety.

The present application is related to my co-pending U.S. Patent Application No. 60/860,567, titled Limited Life Medium, filed Nov. 21, 2006, and U.S. Patent Application No. 60/860,553, titled Limited Life Medium, filed Nov. 22, 2006, which are incorporated herein by reference in their entirety, and to commonly invented and assigned United States Patent Application Publication No. 2005/0195728, which is incorporated herein by reference in its entirety.

### FIELD OF THE INVENTION

The invention relates to media used to distribute information that is to be installed on a device for subsequent use, and to methods of installation of such information. The invention relates especially, but not exclusively, to media used to distribute computer programs that are to be installed and run on a computer.

### BACKGROUND

It is well known to distribute information, for example, computer programs, on a disc or other portable medium. The computer program is then installed on a computer and run on the computer. Such computer programs are commonly supplied, especially to the domestic market, at a price based on the assumption that each copy is to be used by a single consumer on a single computer. However, some purchasers of copies of computer programs install the program, or permit the program to be installed, on more than one computer. Where such multiple installation occurs to any significant extent, the supplier of the computer program, in order to obtain a proper return on the time and resources expended on creating the program, must increase his price, thus penalizing the honest user, and deterring some users from purchasing copies of the program at all.

Commonly invented and assigned U.S. Patent Application Publication No. 2005/0195728 proposes an optical disc that self-destructs within a predetermined period after the disc is first read. The disc described in U.S. Patent Application Publication No. 2005/0195728 contains a reservoir of solvent near its center. The process of reading the disc involves rotating the disc at high speed. Centrifugal force from the rotation redistributes the solvent to a location where the solvent destroys part of the data storage layer. The disc of U.S. Patent Application Publication No. 2005/0195728 is well suited to discs of the CD or DVD type, in which the data storage layer is a thin metal foil, susceptible to destruction by mild acids, and in which the inner edge of the data storage layer carries a vital control track. By suitable selection of the strength of the acid, the time within which the disc becomes unusable can be selected in a range from minutes to days. However, the disc as described in U.S. Patent Application Publication No. 2005/0195728 does not, on its own, prevent an unscrupulous person generating an image of the disc when it is first read, and producing copies of the image on discs that do not have the self-destruct property.

There is therefore a continuing need for an improved disc that more effectively prevents the possessor from installing the information from the disc, directly or indirectly, on more than one computer.

### SUMMARY

The present invention provides a storage medium that contains data including a setup program for installing other parts of the data on a computing device, and that self-destructs in a predictable way over a period of time smaller than the running time of the setup program. The setup program, before it completes the installation, attempts to read apart of the medium that was read earlier but that should by the time of the later reading have been destroyed. If that part of the medium is still readable, the setup program deduces that the medium is not a genuine self-destructing medium but an illicit copy, and terminates without completing the setup process.

The part of the medium in question may be a part of the medium that must be read at an earlier stage of the setup process, for example, the control and index tracks at the inner edge of a CD or DVD, which must be read when reading from the CD or DVD starts. If the information on the part of the medium in question is needed at later stages of the installation process, the setup program stores a copy in the computing device's memory. Alternatively, the part of the medium in question may be a part of the medium that the setup program deliberately reads at an early stage in the setup process.

In general, the term “computing device” is not limited to a general purpose computer, but may apply to any device on which programs or other information can be installed from an external medium, and that has sufficient processing power to run a setup program, and includes systems on which the processing power of one device runs a setup program that installs the information on another device. Many devices not usually called a computer have the necessary capabilities, for example, some of the more sophisticated mobile telephones, and it is expected that with the continuing increase in power and decrease in price of microprocessors the number and variety of such devices will continue to increase.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic drawing of an optical disc.

FIG. 2 is a block diagram of a computer.

FIG. 3 is a flowchart.

### DETAILED DESCRIPTION

Reference will now be made in detail to various embodiments of the present invention, examples of which are illustrated in the accompanying drawings.

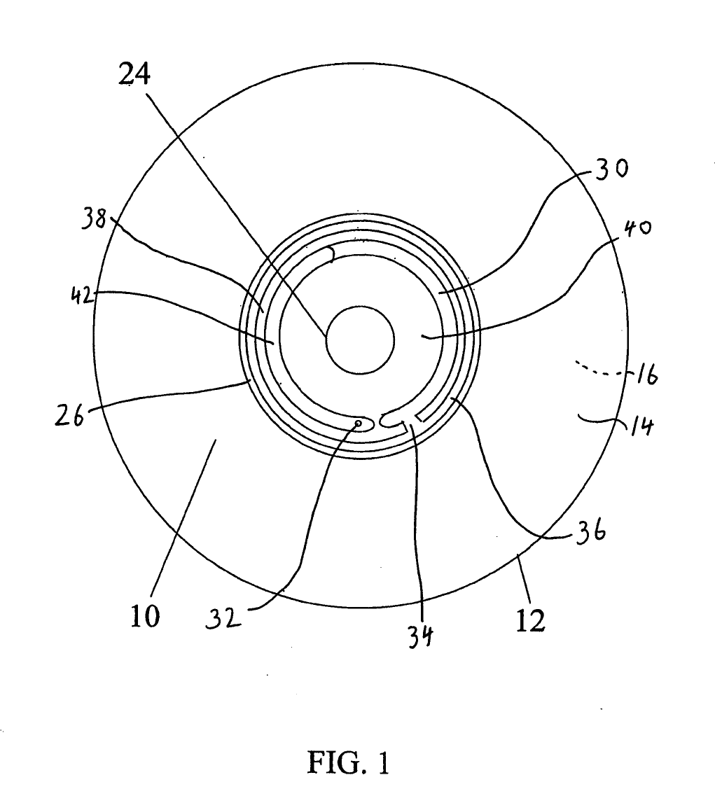

Referring initially to FIG. 1, one embodiment of a storage medium, indicated generally by the reference numeral 10, is in the form of an optical disc, which may be generally similar to the disc 10 shown in U.S. Patent Application Publication No. 2005/0195728. The disc 10 is circular, and has an outer periphery 12.

The optical storage medium 10 is a laminate that consists essentially of, in order, a first rigid substrate, a first layer of reflective material, a layer of adhesive, and a second rigid substrate. A second layer of reflective material, and/or a decorative layer or a layer bearing human-readable indicia, may also be present between the layer of adhesive and the second rigid substrate. The substrates include a central aperture or opening 24 and are made of transparent material, such as glass or plastic, for example, transparent polycarbonate plastic.

In the embodiment, the first reflective layer is an aluminum coating formed on the first rigid substrate, and the second reflective layer, if present, is an aluminum coating formed on the second rigid substrate. The two halves thus formed are then joined together with a layer of hot-melt glue or other adhesive.

The optical storage medium 10 includes readable data or information represented by pits, bumps, dots, or other markings formed in the first reflective layer and having a reflectivity different from the reflectivity of other markings or of unmarked parts of the first reflective layer. The markings are scanned by a laser through the first rigid substrate to read the data. In the embodiment, the markings are preferably pits or dots molded into the surface of the first substrate before the first substrate is coated with the first reflective layer. Various methods for forming the first rigid substrate and the first reflective layer are known and, in the interests of conciseness, will not be further described here.

The second rigid substrate, with the second reflective layer applied to it as a coating, may be similarly formed. The second reflective layer may be a further data storage layer, read either through the first rigid substrate and the first reflective layer, if the first reflective layer is partly reflective and partly transparent, or through the second rigid layer. Alternatively, the second reflective layer may be merely a dummy layer. If the second reflective layer is not used for data storage, it may be omitted. In accordance with the industry standard for DVDs and CDs, the data stored on the first reflective layer starts with a lead-in section 26 at the radially inner edge of the first reflective layer, nearest to the central aperture 24. This configuration is especially suitable for a DVD-9 format disc, in which the first reflective layer is read from the inside outwards, and the second reflective layer is then read from the outside inwards.

A first reservoir 30 is formed in the second rigid substrate, or alternatively in the first rigid substrate. The first reservoir is in the form of an annular groove in the inner face of the second rigid substrate, concentric with the disc 10 and extending round a majority of arc of the disc 10, for example, for approximately 350° of arc. The first reservoir or groove 30 is separated from the central aperture 24 of the disc 10 by a land 40. Near one end, the groove 30 is connected with the exterior by a hole 32 passing through the thickness of the second rigid substrate. Near the other end, the groove 30 is connected by a radial passageway 34 to a second reservoir or groove 36. The second reservoir 36 is annular, and is concentric with the disc 10 and is radially outside the first reservoir 30. A wall 38 separates the first reservoir 30 from the second reservoir 36, and is penetrated only by the radial passageway 34.

The second reflective layer has its inner edge at the outer edge of the second reservoir 36. However, the lead-in section 26 of the first reflective layer overlaps, and forms at least part of one wall of, the second reservoir 36. The first reflective layer does not overlap the first reservoir or groove 30. Preferably, the inner edge of the first reflective layer is outside the wall 38. Because the position of the lead-in section 26 is effectively determined by the industry standard for CDs, DVDs, and similar media, this effectively determines the radial position of the second reservoir 36. If the second reflective layer is the second data layer of a DVD-9 disc, the DVD-9 standard tolerates having the inner, lead-out edge of the second data layer a few millimeters further out than usual.

The adhesive is applied by coating the second rigid substrate, and the second reflective layer already laminated onto the second rigid substrate but not applying any adhesive into or over the recesses forming the reservoirs 30 and 36 and the passageway 34. This ensures that the lead-in section 26 is exposed to the outer reservoir 36, while the inner reservoir 30 is entirely enclosed by polycarbonate and adhesive.

Once the disc 10 has been assembled, a liquid chemical agent 42 is introduced into the first reservoir 30 through the hole 32, which is then sealed. After the liquid 42 is introduced, the hole 32 is then sealed with a drop of adhesive.

In normal storage and handling of the disc 10, the liquid 42 is retained in the part of the first reservoir 30 nearest the hole 32 by surface tension. The amount of liquid introduced is not critical, but it is preferred to approximately half fill the first reservoir 30. This allows a reasonable amount of liquid 42, while leaving a substantial length of dry groove 30, so that even if sudden movements of the disc 10 cause some migration of the liquid 42 it is very unlikely to reach the passageway 34.

However, when the optical storage medium 10 is used, the disc is rotated very rapidly, typically at 1000 rpm, to allow it to be read by a fixed laser. This rapid rotation generates a considerable centrifugal force. Assuming that the first reservoir 30 has a radius of 40 mm, the acceleration experienced by the liquid 42 in the first reservoir is about 218 m/s², or more than 20 times the acceleration due to gravity at the earth's surface. This acceleration drives the liquid 42 to the radially outer edge of the groove 30, and causes it to spread along that edge until it reaches the passageway 34. The liquid 42 then spreads along the outer edge of the second reservoir 36, where it comes into contact with the lead-in section 26 of the data on the first reflective layer 16.

In addition, the starting and/or stopping of the rotation of the disc 10 may involve a significant angular or circumferential acceleration of the disc, and may involve sudden changes in that acceleration. The sudden angular motion of the disc, coupled with the inertia of the liquid 42, may provide an impetus sufficient to propel the liquid circumferentially along the reservoirs 30 and 36, or to assist a movement of the liquid caused by other forces. In addition, vibration of the disc, for example, vibration deliberately caused as described in U.S. Patent Application No. 60/860,553 filed Nov. 22, 2006, may cause or assist the movement of the liquid. Depending on the design of the specific disc and the specific disc drive, any or all forces arising from the motion of the disc, including centrifugal force, angular acceleration, and vibration, may cause or contribute in greater or lesser proportion to the movement of the liquid 42.

The liquid 42 in the first reservoir 30 is a preselected chemical agent that will render the lead-in section 26 of the optical storage medium 10 unreadable after a preselected period of time, by dissolving or otherwise reacting with the aluminum first reflective layer and altering its reflectivity so that the laser cannot read the data. In the preferred embodiment, the liquid 42 dissolves away the aluminum layer over a period of a few minutes. It is not necessary to obliterate the data on the first reflective layer entirely. Merely damaging the lead-in section 24 renders the disc 10 unusable in any standard DVD or CD player, because the player relies on information in the lead-in section to identify and locate the data files stored on the main part of the disc.

The disc shown in FIG. 1 may be substantially the same as the disc shown and described in U.S. Patent Application Publication No. 2005/0195728, and in the interests of conciseness that description is not here repeated in full. Alternatively, the disc may have some or all of the features described in U.S. Patent Application No. 60/860,567 filed Nov. 21, 2006 and/or U.S. Patent Application No. 60/860,553 filed Nov. 22, 2006.

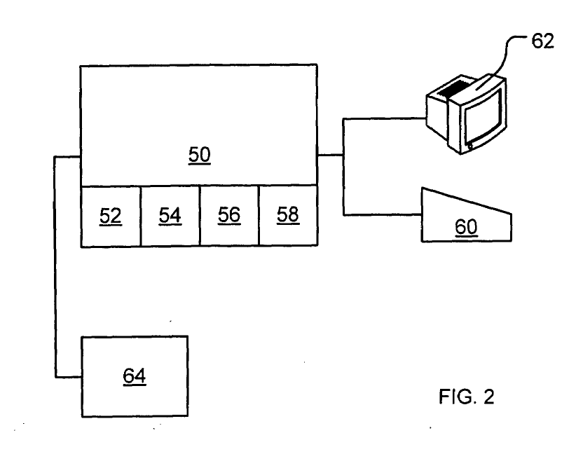

Referring now to FIG. 2, one form of computer, indicated generally by the reference numeral 50, comprises a processor 52, RAM 54, non-volatile storage such as a hard disc 56, and a reader for information storage media, which in one embodiment is a disc drive 58 arranged to read CDs, DVDs, or other discs of the same format as the disc 10 shown in FIG. 1. The computer 50 may also include a keyboard 60 and a display 62, or other user interface devices to enable the computer to be controlled by a user. The computer 50 may also include other devices 64.

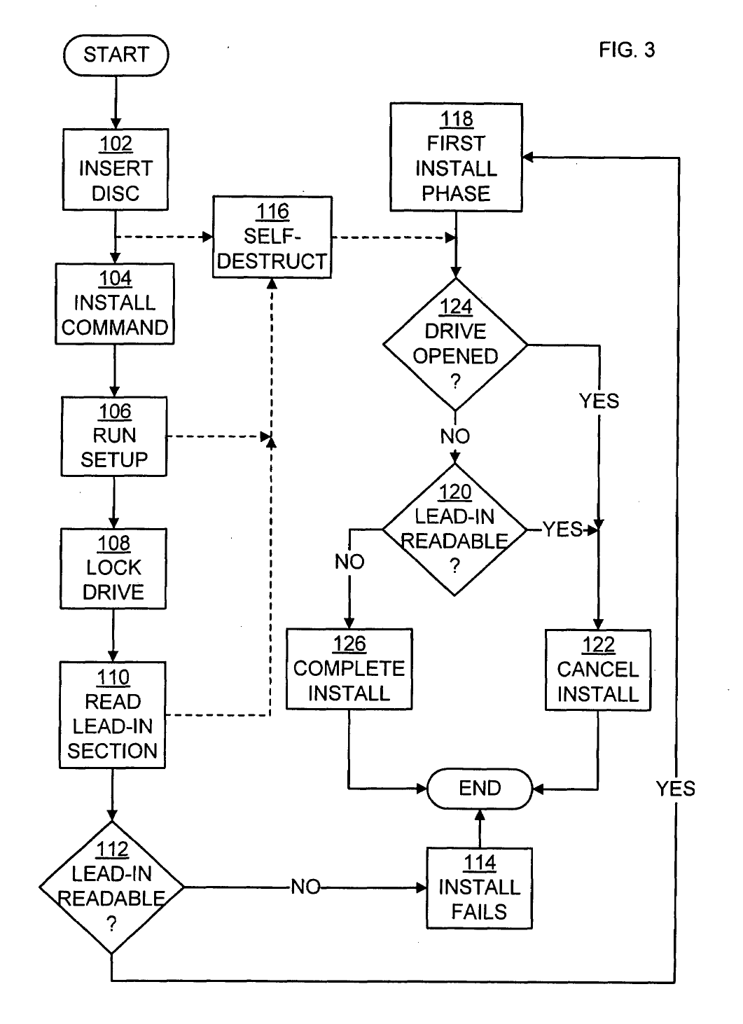

Referring now to FIG. 3, in use of the disc 10, in step 102 the user places the disc in the disc drive 58. In step 104, a command to install information, which may be a computer program, from the disc 10 onto the hard disc 56 of the computer 50 is issued. The command takes the form of a command to an operating system of the computer 50 to run a setup program on the disc 10. The command may be issued by a user through the user interface, or may be generated automatically when the operating system on the computer 50 detects the presence of the disc 10 with the setup program.

In step 106, the setup program starts to run, in step 108, the setup program locks the disc drive 58 to prevent the disc 10 from being removed, and in step 110 the setup program reads information from the lead-in section 26 of the disc 10 and stores that information in the RAM 54 of the computer 50. The setup program may also display a warning to the user on the display 62, explaining that the setup program must not be interrupted.

In step 112, the process determines whether the lead-in section 26 of the disc 10 is readable. If the lead-in section 26 is unreadable at this time, in step 114 the process infers that the disc 10 is a disc that has already been used, or a copy of such a disc, and terminates without installing the program from the disc 10. Step 112 may be an explicit test, but in many instances will be an implicit test resulting from the fact that the processor 52 requires information from the lead-in section 26 in order to locate files or other information required for step 106 or step 110. Thus, although for clarity of FIG. 3 step 112 is shown as an explicit test after step 110, in many practical embodiments steps 112 and 114 will consist of the processor 52 being unable to read the lead-in section 26 of the disc 10. The processor 52 then returns to the user a standard error message indicating that the disc 10 is unreadable, without invoking any programming special to the disc 10.

In step 116, the self-destruction of the disc 10 starts. The exact point at which self-destruction starts depends on the mechanism of self-destruction, and the process for handling the disc. For example, where the disc 10 self-destructs in response to forces generated during the reading of the disc, such as the centrifugal force as described with reference to FIG. 1, and where the disc drive 58 is arranged automatically to read any new disc that is inserted into the drive, the disc is read, and self-destruction starts, between steps 102 and 104. Where the disc drive 58 does not automatically read every disc, the disc 10 may be read, and self-destruction started, only in response to the command given in step 104. In order to minimize uncertainties in the timing of the installation and self-destruction processes, it is preferred to arrange the setup process so that the sequence of steps from the point at which rotation of the disc 10 first occurs to the end of steps 110 and 112 occurs automatically without user intervention.

Assuming that in step 112 the lead-in section 26 was found to be readable, in step 118, the setup program proceeds with a first phase of installing the program or other information on the computer 50 from the disc 10. With current computer programs, that typically requires not merely copying files from the disc 10 to the hard disc 56, but also significant processing by the processor 52 of the computer 50. For example, compressed files may be decompressed, file structures may be created, configuration data may be requested from a user, and so on. The combined effect of the processing time required and the time taken to read a CD-ROM even on a fast computer drive 58 is that installing a computer program from the disc 10 to the computer 50 typically takes several minutes. Step 118 ends before the installation process is completed. The self-destruction process is timed so that the lead-in section 26 is rendered unreadable, at least in part, before the end of step 118. Where the setup program requires the file location data from the lead-in section, the setup program relies on the copy made in step 110. It is advantageous for the setup procedure to be both complex and idiosyncratic, in order to prevent the unscrupulous copyist extracting the files from the disc 10 and combining the files with a generic setup program on a non self-destructing copy disc.

In step 120, the setup program attempts to read the lead-in section 26 of the disc 10. Because the disc 10 is self-destructing, that is no longer possible. If in step 120 the setup program can still read the lead-in section 26, the setup program infers that the disc 10 is an illicit copy without the self-destruction feature. In that case, in step 122 the setup program deletes the parts of the installation that were completed in step 118, and terminates. The setup program may display an error message explaining why it has terminated, and may invite the user to contact the supplier of the disc 10 if the user believes that the disc 10 was genuine and the termination was erroneous.

The locking of the disc drive 58 in step 108 prevents a dexterous user from starting the installation process with a non self-destructing copy disc and then substituting a different disc, for example, a genuine but no longer usable disc 10, before the test in step 120. Where the disc drive 58 cannot be locked in a way that cannot be overridden, the setup program may be arranged to monitor the disc drive in step 124, and to go to step 122 if the disc drive is opened between step 108 and step 120.

If in step 120 the setup program confirms that the lead-in section 26 of the disc 10 is no longer readable, the program concludes that the disc 10 is a genuine self-destructing disc, proceeds to step 126 and completes the installation of the program or other information from the disc 10. The setup program then unlocks the disc drive 58 and terminates normally.

Aluminum, which is a material widely used for the reflective layers of CD and DVD discs, has relatively low reactivity in that, due to its characteristics, it is protected by a cover of oxide at any time. Despite this low reactivity, aluminum is known to react to certain chemicals under certain conditions and circumstances when the aluminum oxide is dissolved by a chemical agent that can, because of the dissolution of the oxide, react with the aluminum. For example, aluminum is sensitive to bases such as NaOH or KOH, acids such as HCl, H₂SO₄, HNO₃, and citric acid, and several metallic salts, such as CuSO₄, as a few examples.

The properties of these chemical agents may be advantageously used to facilitate and control the rate of dissolution or corrosion of the aluminum. For example, the corrosion of an aluminum reflective layer 16 may be steady and uniform with certain agents, such as NaOH or HCl, or the layer may become pitted upon exposure to agents such as CuSO₄.

In particular, a solution of NaOH with a concentration of 0.06 g/l and a pH of 11 generates a rate of dissolution of the aluminum reflective layer 16 ranging anywhere between approximately 0.3 micron per hour and approximately 1.0 micron per hour. In a typical DVD, the thickness of the aluminum reflective layers is typically 40 or 50 nanometers. With the above-mentioned NaOH solution, therefore, an operating life of from 2½ to 10 minutes will result, which is reasonable for the present purpose. If a longer operating life is desired, inhibitors like soda silicate can reduce or delay the action of NaOH, thereby reducing the rate of dissolution of the aluminum of the reflective layer 16, and extending the period over which the data will become unreadable. Alternatively, the operating life could be adjusted by changing the thickness of the aluminum layer and/or the concentration of the NaOH solution.

Other examples of suitable agents 42 include: a concentrated aqueous solution of NaCl and CuSO₄, giving an operating life of approximately 10 minutes in a disc 10 where the reflective layer is aluminum; a solution of 1% NaCl and 1% CuSO₄ in a medium of 80% propylene glycol and 20% water, giving an operating life of approximately 5 minutes in a disc 10 where the reflective layer is aluminum on copper; a solution of 1% NaCl and 1% CuSO₄ in a medium of 80% propylene glycol and 20% water, giving an operating life of approximately 5 minutes in a disc 10 where the reflective layer is silver; and a solution of from 1% to 15% KCl in a medium of 80% propylene glycol and 20% water, giving an operating life of approximately 5 minutes in a disc 10 where the reflective layer is silver. The KCl composition used with a silver disc is presently preferred. The glycol and water mixture is further described in co-pending U.S. Patent Application No. 60/860,567, filed Nov. 21, 2006.

Care should be taken that the liquid chemical agent 42 does not dissolve the polycarbonate or other material of the substrates 14 and 22, and does not dissolve the adhesive 18. Even if the disc 10 is kept for a long period after it ceases to be usable, the liquid 42 is unlikely to dissolve out along the layers of reflective material 16 and 20 and escape at the edge of the disc, because of the narrowness of the gap that would be formed by such dissolution. The liquid 42 should, however, not be such a strong corrosive agent that it would create a hazard to persons or property if the liquid were released by breaking the disc 10.

Another factor is the type of metallic material used for the reflective layer 16. Although aluminum is presently widely used, other types of metallic material having properties similar to aluminum may be used with the optical storage medium 10. Therefore, the type of metallic material used for the reflective layer 16 should be taken into account to determine the type, concentration, and amount of the chemical agent 42 needed. The same reagents mentioned above may be used, in approximately the same concentrations, with silver as the reflective layer.

Because the liquid chemical agent 42 is retained in the first reservoir 30 solely by capillary action, the surface tension of the liquid and the readiness with which that liquid wets the material forming the first reservoir and the second reservoir 36 are important. It has been found that with a water-based liquid 42 that does not contain any additives materially altering the surface tension or wetting properties, and polycarbonate substrates 14 and 22, a first reservoir from 0.03 mm to 0.4 mm deep in the axial direction is suitable. A depth of 0.25 mm is presently preferred. In the embodiment shown in the drawings, the radial width of the first reservoir 30 is 3.5 mm. Because of the large difference between the width and the depth, only the depth is important. If the reservoir 30 is too shallow, then the liquid 42 will not reliably be forced to flow by the centrifugal force at the normal operating speed of a CD or DVD. If the reservoir 30 is too deep, then the liquid 42 may flow out too easily before the disc 10 is used.

Other liquids, for example, a glycol and water mixture, as described in U.S. Patent Application No. 60/860,567, filed Nov. 21, 2006, may be used, but may require different dimensions for the reservoirs 30 and 36. For example, an alcohol-based liquid may wet the substrates more readily than water, and may therefore require a shallower reservoir. Also, if an ink is added to make the liquid 42 visible, and thus make it easier to see if the liquid has been expelled into the second reservoir, it should be borne in mind that many inks contain a surface active agent that may affect the behavior of the liquid.

While it is not necessary for the liquid 42 to spread round the entire periphery of the second reservoir 36, it is desirable for the liquid to spread freely. Because the second reservoir 36 is bounded partly by the aluminum or other reflective material of the lead-in section 26, the behavior of the liquid 42 may be different in the first and second reservoirs. The water-based liquids, including glycol-and-water mixtures, mentioned above are particularly suitable in the present embodiments, because they wet aluminum and silver more readily than they wet polycarbonate, so they flow more freely in the second reservoir 36 than in the first reservoir 30.

Various modifications and variations can be made in the present invention without departing from the spirit or scope of the invention.

For example, the disc shown in FIG. 1 may be substantially the same as the disc shown and described in U.S. Patent Application Publication No. 2005/0195728. Alternatively, other forms of self-destructing storage medium, including forms already known in the art and forms hereafter to be developed, may be used, provided that the self-destruction process has the characteristics to enable the present invention to be put into effect.

For example, the disc may be formed in whole or in part of a medium that is erased by the device used to read the medium. For example, writable CDs are usually designed so that the laser beam used to write the CD is more powerful than the laser beam used to read the CD. However, a CD could be constructed part or all of which is of a material that is sufficiently sensitive to be erased by one or more passes of the ordinary reading beam. Provided the stored data can be read once before it is erased, such a disc could be used in the process of the present invention.

A disc 10 has been described in which the destruction process is initiated by the rotation of the disc incidental to the act of reading the disc. Alternatively, other mechanisms for initiating the self-destruction of the disc may be used. For example, discs have been previously proposed in which removing a disc from its packaging initiates the self-destruction. Such a packaged disc can be used for the present process. However, it is common in practice for a user to remove a disc from its packaging and then delay reading the disc. With the very short working life of discs according to the present invention, even a short delay in reading the disc could result in the disc becoming unusable. It is therefore preferred to use a mechanism by which self-destruction does not start until the process of installing from the disc starts.

Although the destruction of the lead-in section of a CD-ROM or DVD disc provides a simple and effective embodiment of the invention, other parts of the information on a storage medium could be destroyed, depending in part on the arrangement of the specific storage medium. For example, any part of the data required by the setup program, including parts of the setup program itself, could be destroyed, provided it is read before it is destroyed, and either ceases to be of further use or is stored elsewhere, for example by being installed on the hard disc 56 or stored in the RAM 54, before it ceases to be readable on the original disc 10. Alternatively, information could be provided that is present solely in order to be destroyed, but that is less preferred because the disc 10 could then be more easily reused with a modified setup program.

Depending in part on the computers 50 onto which the disc 10 is expected to be run, the period between steps 110 and 120, during which the lead-in section of the disc 10 is to become unreadable, may be determined by the speed at which the setup program can run. Alternatively, as a precaution against future increases in the speed of computers and disc drives, the setup program may use a clock available on or through the computer 50 to ensure that sufficient time elapses between steps 110 and 120.

As has been indicated in some of the examples mentioned above, a disc with an operating life of approximately 5 minutes is presently preferred. In practice, the operating life may range from about half the nominal value to about twice the nominal value, in the example from about 2½ minutes to about 10 minutes, depending on manufacturing tolerances, on environmental factors that may affect the mechanical and chemical of the agent 42, and the inherent uncertainties of the process. However, different optimum values may be determined for a specific use, and the optimum values may change over time as computer hardware and software continues to develop. Such differences and changes are within the scope of the present invention.

Although an embodiment has been described in which a computer program is installed on a computer from the limited-life disc 10, other uses are possible, for example, installation of data files from the disc 10 onto the computer. The disc 10 could also be used for, for example, a program that is run directly from the disc 10. In step 126 of FIG. 3, the program would then continue running until the program reached a natural or programmed termination or was closed by the user, but could not be restarted once it had been closed.

Thus, it is intended that the present invention cover the modifications and variations of this invention provided they come within the scope of the appended claims and their equivalents.

What is claimed is:

1. A storage medium containing information including a setup program comprising instructions for causing a computing device to deliver other parts of the information to the computing device;
wherein the selected part of the information comprises information that in normal use of the medium is read before a first predetermined time; and
wherein the setup program includes instructions to read the selected part of the information after a second predetermined time later than the first predetermined time, and instructions to terminate the setup program without installing the other parts of the information if the selected part of the information is still readable after the second predetermined time.

2. A storage medium according to claim 1, so constructed that in normal use reading the storage medium causes at least a selected part of the information on the storage medium to become unreadable later than the first predetermined time but within the second predetermined time.

3. A storage medium according to claim 1, wherein the selected part of the information is information selected from information that the computing system reads in order to run the setup program and information the setup program reads before the predetermined time, and combinations thereof.

4. A storage medium according to claim 1, wherein the setup program comprises instructions to store the selected part of the information on the computing device.

5. A storage medium according to claim 1, which is a disc arranged to be rotated when read, and wherein the destruction of the selected part of the information is caused or initiated by the rotation of the disc.

6. A storage medium according to claim 5, wherein the rotation of the disc causes a reagent to move into contact with an information bearing substrate.

7. A storage medium according to claim 1, wherein the information to be installed comprises a program arranged to run on the computing device.

8. A method of distributing information, comprising:
providing the information on a storage medium;
commencing reading of the storage medium and delivery of the information from the storage medium;
not delivering the information or interrupting delivery of the information from the storage medium if the selected part of the information is unreadable before a first predetermined time;
attempting to read the selected part of the information after a second predetermined time later than the first predetermined time; and
interrupting delivery of the information from the storage medium if the selected part of the information is still readable after the second predetermined time.

9. A method according to claim 8, comprising:
providing the information on a storage medium, wherein the storage medium is so constructed that in normal use reading the storage medium causes at least a selected part of the information on the storage medium to become unreadable after the first predetermined time but within the second predetermined time.

10. A method according to claim 8, wherein delivery of the information comprises installation of the information on a computing device.

11. A method according to claim 8, wherein the information comprises a computer program, and the delivery of the information comprises installation of the computer program on the computing device.

12. A method according to claim 8, wherein delivery of the information comprises running a setup program provided on the storage medium, and the setup program is arranged to carry out the reading and interrupting.

13. A method according to claim 8, wherein the selected part of the information comprises information used by a reader to recognize a type of the medium or to locate other information on the medium; and
wherein not delivering the information or interrupting delivery of the information from the storage medium if the selected part of the information is unreadable at the commencement of reading comprises the reader failing to read the medium.

14. A method according to claim 8, wherein the selected part of the information comprises information selected from information that the computing system reads in order to run the setup program, information the setup program reads before the first predetermined time, and combinations thereof.

15. A method according to claim 8, further comprising storing the selected part of the information on a computing device to which the information is being delivered.

16. A method according to claim 8, wherein the storage medium is a disc arranged to be rotated when read, and wherein the destruction of the selected part of the information is caused or initiated by the rotation of the disc, the method further comprising rotating the disc in order to read the disc, and thereby causing or initiating the destruction of the selected part of the information.

17. A method according to claim 16, further comprising causing a reagent to move into contact with an information bearing substrate by rotating the disc.

18. A method according to claim 11, wherein the information being distributed comprises a program arranged to be installed and run on a computing device, comprising:
causing the computing device to read the storage medium using a reader of the computing device and to deliver the information from the storage medium to the computing device;
causing the computing device to read the selected part of the information after the predetermined time from the commencement of reading; and
causing the computing device to interrupt delivery of the information from the storage medium if the selected part of the information is still readable after the predetermined time.
